(19) United States
(12) Patent Application Publication
(10) Pub. No.: US 2018/0134371 A1
(43) Pub. Date: May 17, 2018

(54) AIR BRAKE SYSTEM FOR AIRCRAFT

(71) Applicant: AIRBUS OPERATIONS SL, Madrid (ES)

(72) Inventor: Ladislao LÓPEZ LÓPEZ, Madrid (ES)

(21) Appl. No.: 15/815,022

(22) Filed: Nov. 16, 2017

(30) Foreign Application Priority Data
Nov. 17, 2016 (EP) 16199342.3

(51) Int. Cl. B64C 9/12; B64C 9/32; B64C 13/16; B64C 9/16

(52) U.S. Cl. CPC B64C 9/12; B64C 9/16; B64C 13/16; B64C 9/323

(57) ABSTRACT

An air brake system for aircraft comprising control surfaces, such as slats, flaps and spoilers mounted to the wings of an aircraft, wherein each control surface is split, along a spanwise direction, into parts of the control surface, and the parts of each control surface are deployed desynchronously when the aircraft touches down.

### FIELD OF THE INVENTION

This application claims priority to European Patent Application EP16199342.3 filed Nov. 17, 2016, the entirety of which is incorporated by reference.

### FIELD OF THE INVENTION

The present invention is in the aeronautical field, and particularly to the field of aircraft brake systems and processes that manage aircraft brake systems to provide deceleration and shorter landing distances for an aircraft.

### BACKGROUND OF THE INVENTION

As shown in FIG. 1, a commercial aircraft 10 may include a set of brake systems, such as: a landing gear brake, thrust reversers and air brakes system.

The landing gear brake is performed in the body of the landing gear 20 while the aircraft 10 is touching the ground called also “touchdown”.

The thrust reversers allow thrust from the engines 30 to be used to slow the aircraft 10 just after touchdown.

The air brakes system are dedicated flight control surfaces 42, 43, 44, 45, 52, 53, 54, 55, able to work to increase the drag to reduce the velocity to allow the landing phase. Currently the air brake systems of commercial aircraft use exclusively the dedicated flight control surfaces 42, 43, 44, 45, 52, 53, 54, 55 of each wings 40, 50.

It's well known that an aircraft 10 has a set of control surfaces to allow the pilot to control movements of the aircraft 10 during the take-off, cruise, approaching and landing phases. Particularly during the critical phases of flight, such as approaching and landing phases, these control surfaces 41, 42, 43, 44, 45, 51, 52, 53, 54, 55, play an additional role to slow the aircraft 10, while the pilot is also using the control surfaces to control the attitude and stability of the aircraft 10 in a low-speed condition.

Modern aircrafts are generally equipped with two basic kind of control surfaces. A primary kind of flight control surfaces allow to control the aircraft torques around their main axis, such as:

(i)ailerons 41, 51 which are mounted on the trailing edge 48, 58 of each wing 40, 50 near the wing tips 49, 59, to control the roll R rotation,

(ii) elevators 61, 62 which are moveable parts of the Horizontal Tail Plane (“HTP”) 60 of the empennage 15 to control the pitch P rotation of the aircraft , and

(iii) a rudder 71 which is typically mounted on the trailing edge of the Vertical Tail Plane (“VTP”) 70 of the empennage 15 in order to control the yaw Y rotation of the aircraft 10.

A second kind of flight control surfaces are high-lift devices such as slates, 45, 55, flaps 44, 54 and spoilers 42, 52

The slats 45, 55, are also known as leading edge 47, 57 devices, and are extensions to the front of a wing 40, 50 for lift augmentation, and are intended to reduce the stall speed by altering the air flow over the wing 40, 50.

The flaps 44, 54 are mounted on the trailing edge 58 of each wing 40, 50.

The spoilers 42, 52 are used to disrupt airflow over the wing 40, 50 and greatly reduce lift, allow a glider pilot to lose altitude without gaining excessive airspeed.

These second kind of flight control surfaces tend to lower the minimum speed at which the aircraft 10 can be safely flown, and to increase the angle of descent for landing.

These second kind of flight control surfaces are extended or deployed during critical phases as approaching or landing, and are controlled by a Flight Management System (“FMS”) of the aircraft to operate safely. Once the aircraft 10 touches down, the flight control system (FMS) via a brake control system deploys air brakes such as spoilers 42, 52, placed on the wing 40, 50 to slowdown the aircraft 10 assisting the brake system, in addition to the landing gear break system and the thrust reverse mode.

The majority of the flight control surfaces 41, 42, 43, 44, 45, 51, 52, 53, 54, 55, are allocated on the wings 40, 50, because the wings have greater aerodynamic surfaces than do the VTP 70 or HTP 60.

Large airports are typically already operating at capacity for aircraft landings and takeoffs. Also, the demand is expected to increase for aircraft landings and take-offs at large airports. Thus there is a need to accommodate the increasing demand and effectively increase the capacity of airports.

A factor in determining the capacity of an airport is the period from when an aircraft touches down on a runway and the aircraft leaves the active runway. Decreasing this period would allow the runway to be more quickly used for touchdown or takeoff of another aircraft. Thus decreasing his period effectively increases the capacity of a runway and its airport by allowing more aircraft to land and takeoff using the runway.

### SUMMARY OF THE INVENTION

The present invention is directed to an air brake system for aircraft such as with the same flight control surface available, it is possible to increase the drag and consequently reduce the landing phase.

An invention has been conceived and is disclosed herein in which a movable control system is provided relative to an aircraft stabilizer, wherein the movable control surfaces provide longitudinal and/or directional stability and control to an aircraft, such as each control surface is split in the spanwise direction in at least two parts. The at least two parts of the control surface are configured to be deployed desynchronously when the aircraft touches down during landing. Desynchronous deployment may be deploying the at least two parts of each control surface in opposite directions, such as one part deployed up and the other part deployed down. The control surfaces may be slats, flaps, spoilers and control surfaces on aircraft stabilizers.

The set of slats may be mounted on leading edge of each wing of the aircraft, able to extent to the front of the wings, in order to reduce the stall speed by altering the air flow over the wings;

The set of flaps may be mounted on the trailing edge of each wing of the aircraft, able to extent to the rear of the wings, in order to reduce the stall speed by altering the air flow over the wings;

The set of spoilers may be located over each wings of the aircraft, able to disrupt airflow over the wings and greatly reduce lift; and,

The control surfaces on the aircraft stabilizers include movable control surfaces that are split in the spanwise direction and the parts of the split control surface are deployed desynchronously when the aircraft touches down.

The invention may also be embodied in an air brake control systems that manages different brake systems on an aircraft, including managing of a landing gear brake, thrust reversers, and air brake systems.

The landing gear brake may be in the body landing gear and applied while or just after the aircraft touches down on a runway during landing, and/or

The thrust reversers, to allow to use the thrust from the engines to slow down the aircraft when the said aircraft touches down, and/or

The air brakes systems may comprise:

(i) a dedicated flight control surfaces on the wings, able to work sequentially in order to increase the drag to reduce the velocity and the angle of approach to allow the landing phase, and

(ii) a movable control surfaces of the aircraft stabilizer according the previous claims, split in the spanwise direction in at least two parts, configured to be deployed desynchronously when the aircraft touches down.

### BRIEF DESCRIPTION OF THE DRAWINGS

To complete the description and in order to provide for a better understanding of the invention, a set of drawings is provided. Said drawings form an integral part of the description and illustrate preferred embodiments of the invention. The drawings comprise the following figures:

FIG. 1 shows a schematic representation of an aircraft according to the state of art.

FIG. 2 shows a schematic representation of aircraft stabilizer according to a preferred embodiment to the invention.

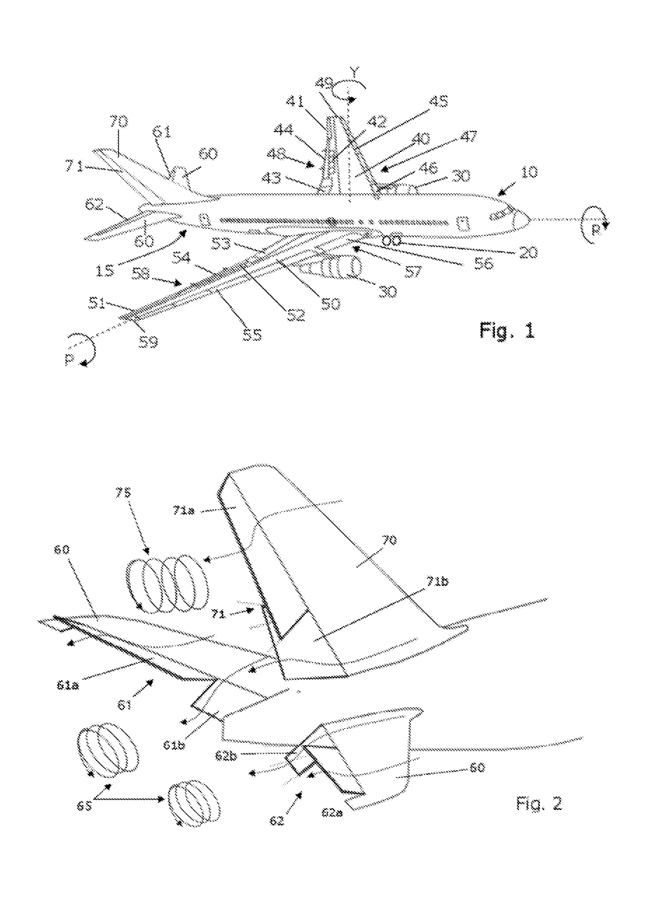

### DETAILED DESCRIPTION OF THE DRAWINGS

The present invention is directed generally toward air brakes systems, and associated systems. Several embodiments of the systems and process to manage this systems are described below. A person skilled in the relevant art will understand, however, that the invention may have additional embodiments, and that the invention may be practiced without several of the details of the embodiments described below with reference to FIG. 2.

FIG. 2 shows an empennage 15 comprising a set of aircraft stabilizer, such as a Horizontal Tail Plane 60, and a Vertical Tail Plane 70. The Horizontal Tail Plane 60 comprises respectively a left 61 and right 62 movable control surfaces. The Vertical Tail Plane 70 comprises a movable control surface 71. The movable control surface 61, 62, 71 are respectively able to provide a longitudinal and/or directional stability and control to an aircraft 10.

Each control surface 61, 62, 71 is respectively split in the spanwise direction in at least two parts 61a, 61b, 62a, 62b, 71a, 71b, configured in order to be deployed desynchronously when the aircraft 10 touches down in order to increase the drag 65, 75.

The right 61a, 61b and left 62a, 62b parts respectively of the control surfaces 61, 62, of the elevator 60 are consecutively deployed after touchdown in opposite directions, such as to create a drag 65. The parts 71a, 71b of the control surface 71 are deployed in opposite directions to create a drag 75 and thereby slow the speed of the aircraft after landing on the runway. The deployment may be consecutively such that certain parts, such as 61b and 62b are first deployed downward and other parts such as 61a and 61b are deployed upward.

The air brake system of the aircraft 10 is able to use the sets of control surfaces 42, 43, 44, 45, 46, 52, 53, 54, 55, 56, such as:

(i) the set of slats 45, 46, 55, 56, mounted on leading edge 47, 57 of each wing 40, 50 of the aircraft 10. This set of slats is able to extent to the front of the wings 40, 50, in order to reduce the stall speed by altering the air flow over the wings 40, 50;

(ii) the set of flaps 44, 54, mounted on the trailing edge 48, 58 of each wing 40, 50 of the aircraft 10. This set of flaps 44, 54, is able to extent to the rear of the wings 40, 50, in order to reduce the stall speed by altering the air flow over the wings 40, 50;

(iii) the set of spoilers 42, 43, 52, 53, located over each wings 40, 50 of the aircraft 10 This set of spoilers is able to disrupt the airflow over the wings 40, 50 and greatly reduce lift;

Furthermore the air brake system may be configured to activate these control surfaces 42, 43, 44, 45, 46, 52, 53, 54, 55, 56 and one or more of the control surfaces on the HTP and/or VTP which include:

(i) the movable control surfaces 61, 62 of the Horizontal Tail Plane such as said control surfaces 61, 62 are respectively split in the spanwise direction in at least two parts 61a, 61b for the left side and 62a, 62b for the right side. The parts 61a and 61b, and parts 62a are 62b are able to move by independent actuators configured to be synchronized in all different movement of the aircraft 10, such as during the take-off, cruise, approaching and landing phases. The synchronized movements of the parts 61a and 61b of control surface 61 and 62a and 62b of control surface 62

The said activators of the part 61a, 61b, 62a, 62b are able to be deployed de-synchronized on request of the pilot on the Flight Management System exclusively when the aircraft touches down; or,

(ii) the movable control surface 71 of the Vertical Tail Plane such as said control surface 71 being split in the spanwise direction in at least two parts 71a, 71b. The said part 71a, 71b are able to move by independent activators configured to be synchronized in all different movement of the aircraft 10, such as during the take-off, cruise, approaching and landing phases. The said activators of the part 71a, 71b, are able to be deployed de-synchronized on request of the pilot on the Flight Management System exclusively when the aircraft touches down; or,

(iii) both of these movable control surfaces able to be used together in de-synchronized mode to increase the drag 65, 75.

The brake control systems for aircraft 10 is able to manage the different brake systems via the activation of:

(i) a landing gear brake, this brake is performed in the body landing gear 20 while the aircraft 10 touches down, and/or

(ii) thrust reversers, to allow to use the thrust from the engines 30 to slow down the aircraft 10 when the said aircraft touches down, and/or

(iii) air brakes systems comprising: (a) dedicated flight control surfaces 42, 43, 44, 45, 46, 52, 53, 54, 55, 56 on the wings 40, 50, able to work sequentially in order to increase the drag to reduce the velocity and the angle of approach to allow the landing phase, and (b) movable control surfaces 61, 62, 71 of the aircraft stabilizer 60, 70, split in the spanwise direction in at least two parts 61a, 61b, 62a, 62b, 71a, 71b, configured to be deployed desynchronously when the aircraft touches down.

From the foregoing, it will be appreciated that specific embodiments of the invention have been described herein for purposes of illustration, but that various modifications may be made without deviating from the spirit and scope of the invention. For example, aspects of the invention described in the context of particular embodiments may be combined or eliminated in other embodiments. Although advantages associated with certain embodiments of the invention have been described in the context of those embodiments, other embodiments may also exhibit such advantages. Additionally, none of the foregoing embodiments need necessarily exhibit such advantages to fall within the scope of the invention. Accordingly, the invention is not limited except as by the appended claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

The invention is:

1. An aircraft stabilizer comprising:
movable control surfaces on an aircraft and configured to provide longitudinal and/or directional stability and control to the aircraft;
wherein each control surface of the moveable control surfaces is split in the spanwise direction in at least two parts, and
wherein the at least two parts for each control are configured to be deployed desynchronously when the aircraft touches down.

2. The aircraft stabilizer according to claim 1, wherein the respective parts of each control surface are configured to be consecutively deployed in opposite direction.

3. An air brake system for an aircraft comprising:
the aircraft stabilizer of claim 1, and
wing mounted movable control surfaces mounted to wings on an aircraft, wherein the moveable control surfaces include at least one of:
slats mounted on a leading edge of the wings and are configured to extent forward of the wings;
flaps mounted on trailing edges of the wings and are configured to extend aft of the wings;
spoilers mounted to upper regions of the wings and configured to extend upward from upper external surfaces of the wings.

4. The air brake system for aircraft according to claim 3, where in the at least two parts of each stabilizer mounted control surface are consecutively deployed in opposite directions.

5. An air brake control system for an aircraft comprising:
flight control surfaces on wings of an aircraft, wherein the flight control surfaces are configured to deploy sequentially to increase drag and thereby reduce a velocity and angle of approach of an aircraft during a landing approach, and
a movable control surfaces of an aircraft stabilizer of the aircraft which are split in a spanwise direction in at least two parts and configured to deploy desynchronously when the aircraft touches down.

6. A control surface on an empennage stabilizer of an aircraft comprising:
a tail plane having a fixed aerodynamic surface;
a moveable control surface mounted to the tail plane and configured to move in response to control inputs to provide pitch, yaw or roll movement of the aircraft during flight;
the moveable control surface has a first part and a second part, wherein the first and second parts are arranged in a spanwise direction along the control surface, wherein the first and second parts move together and synchronously to provide pitch, yaw or roll movements while the aircraft is in flight, and the first and second parts move in opposite directions after the aircraft has touched down during a landing and while the aircraft slows along a runway.

7. The control surface of claim 6 where the control surface is at least one of:
a vertical control surface mounted to a trailing edge of a vertical tail plane, and the parts of the vertical control surface are each mounted to the trailing edge of the vertical tail plane, and
horizontal control surfaces each mounted to one of a pair of horizontal tail planes, and the parts of the horizontal control surfaces are each mounted to one of the trailing edges of the pair of the horizontal control surfaces.

8. The control surface of claim 6 wherein the first and second parts each after a leading edge facing a trailing edge of the tail plane and a trailing edge at a trailing edge of the control surface, and
the first and second parts each have a side edge facing a side edge of the other of the first and second part.

9. A method to move a control surface on a tail plane an aircraft comprising:
moving first and second parts of the control surface together and in synchrony such that the first and second parts move to provide uniform pitch, yaw or roll movements to the aircraft while the aircraft is in flight, and
moving the first and second parts of the control surface in opposite directions to increase separately, in desynchrony as a and in the same direction after the aircraft has touched down on a runway and is slowing while moving down the runway.

10. The method of claim 9 wherein the movement of the first and second parts in opposite directions is performed automatically after the aircraft has touched down.
